(19) United States
(12) Patent Application Publication
(10) Pub. No.: US 2024/0387839 A1
(43) Pub. Date: Nov. 21, 2024

(54) Fuel Cell and corresponding Method for Manufacturing Fuel Cell

(71) Applicant: Robert Bosch GmbH, Stuttgart (DE)

(72) Inventors: Xiaogang Hao, Shanghai (CN); Xu Xie, Shanghai (CN); Jingjun Zhang, Shanghai (CN)

(21) Appl. No.: 18/693,330

(22) PCT Filed: Sep. 30, 2021
(86) PCT No.: PCT/CN2021/122231

§ 371 Date: Mar. 19, 2024

(51) Int. Cl. H01M 8/0273; H01M 8/0265; H01M 8/0286; H01M 8/1004

(52) U.S. Cl. CPC H01M 8/0273; H01M 8/0265; H01M 8/0286; H01M 8/1004

(57) ABSTRACT

A fuel cell includes (i) a membrane electrode assembly, (ii) a sealing frame surrounding the membrane electrode assembly, (iii) a manifold portion configured to supply and discharge reactant gas, and (iv) bipolar plates arranged on both sides of the membrane electrode assembly and the sealing frame and having a gas distributing structure configured to distribute the reactant gas onto the membrane electrode assembly. The sealing frame has a gas flow channel extending from the manifold portion in a main extension plane of the fuel cell to the gas distributing structure of the bipolar plates. The gas flow channel has a shape with a winding path, at least partially, in the main extension plane. Also disclosed is a corresponding method for manufacturing a fuel cell that is capable of reducing deformation of the sealing frame in the perpendicular direction and avoiding collapse of the gas flow channel, while preventing a significant drop in gas pressure.

### TECHNICAL FIELD

The present disclosure relates to a fuel cell. Further, the present disclosure relates to a corresponding method for manufacturing the fuel cell.

### BACKGROUND ART

In recent years, with the development of society and the economy, there has been increasing concern about issues such as air pollution and energy consumption. Fuel cells are efficient power generation devices that directly convert the chemical energy in fuel and oxidizing agents into electrical energy through an electrochemical reaction without combustion. Due to the production of water as the main reaction product and minimal emission of harmful gases, fuel cells have significant advantages in terms of being clean and environmentally friendly, especially in the field of vehicles.

In a fuel cell, fuel, for example, hydrogen, is supplied and distributed to the anode-side electrode and an oxidizing agent, for example, air containing oxygen, is supplied and distributed to the cathode-side electrode. To this end, a manifold portion for supplying and discharging reactant gas, i.e., fuel and oxidizing agents, is disposed in the fuel cell, and a gas distributing structure for distributing the reactant gas is arranged in bipolar plates. Further, to ensure the safety and efficiency of the fuel cell, a seal needs to be disposed between the manifold portion and the bipolar plates, which results in the manifold portion and gas distributing structure not being in direct communication.

In prior art, in order to direct the reactant gas in the manifold portion into the gas distributing structure of the bipolar plates, air holes are typically disposed in the bipolar plates for gas to pass through, and the reactant gas in the manifold portion enters the gas distributing structure of the bipolar plates through the air holes. However, opening air holes in the bipolar plates not only complicates the manufacturing process of the bipolar plates, but also results in a significant drop in pressure of reactant gas flow, which adversely affects the supply and distribution of the reactant gas, and may even compromise the operating performance of the fuel cell in serious cases.

### SUMMARY OF THE INVENTION

Therefore, the objective of the present disclosure is to propose an improved fuel cell, in which a gas flow channel of the gas distributing structure for connecting the manifold portion and bipolar plates may be easily and cost-effectively formed, avoiding having to open holes on the bipolar plates, thereby preventing a significant drop in gas pressure. Further, it is also capable of advantageously avoiding deformation of a sealing frame in a direction perpendicular to a main extension plane and minimizing the risk of collapse of the gas flow channel while ensuring the sealing effect of the sealing frame. Further, it is also the objective of the present disclosure to propose a corresponding method for manufacturing the fuel cell.

According to a first aspect of the present disclosure, a fuel cell is provided, the fuel cell at least comprising:
a membrane electrode assembly;
a sealing frame surrounding the membrane electrode assembly;
a manifold portion configured to supply and discharge reactant gas;
bipolar plates arranged on both sides of the membrane electrode assembly and the sealing frame and having a gas distributing structure configured to distribute the reactant gas onto the membrane electrode assembly, wherein
a gas flow channel is provided in the sealing frame, the gas flow channel extending from the manifold portion in a main extension plane of the fuel cell to the gas distributing structure of the bipolar plates, wherein the gas flow channel has a shape with a winding path, at least partially, in the main extension plane.

According to the present disclosure, disposing the gas flow channel to extend from the manifold portion to the gas distributing structure of the bipolar plates in the sealing frame allows for a cost-effective fluid connection between the manifold portion and the gas distributing structure, without the need to dispose air holes in the bipolar plates, significantly simplifying the manufacturing process of the bipolar plates and providing a higher degree of freedom in the design of the bipolar plates while also maintaining airflow pressure. Further, the winding path configuration of the gas flow channel in the main extension plane is better able to withstand clamping force applied by the bipolar plates in the perpendicular direction, thereby reducing deformation of the sealing frame in the perpendicular direction and avoiding collapse of the gas flow channel, thereby more effectively ensuring the safety and efficiency of the fuel cell and avoiding adverse effects on the functionality of the fuel cells.

A second aspect of the present disclosure provides a method for manufacturing the fuel cell according to the present disclosure, the method at least comprising the following steps:
S1: placing a prepared membrane electrode assembly in a pre-designed mould;
S2: injecting a sealing material in the liquid state into the mould and curing so as to form the sealing frame, wherein the gas flow channel is disposed in the sealing frame;
S3: assembling the bipolar plates on both sides of the membrane electrode assembly and the sealing frame,
wherein the gas flow channel extends from the manifold portion of the fuel cell to the gas distributing structure of the bipolar plates in the main extension plane of the fuel cell and the gas flow channel has a shape with a winding path, at least partially, in the main extension plane.

### DESCRIPTION OF ACCOMPANYING DRAWINGS

The present disclosure is described in greater detail with reference to the accompanying drawings below to provide a better understanding of its principles, features, and advantages. The accompanying drawings comprise:

FIG. 1 shows a partial sectional view of a fuel cell according to an exemplary embodiment of the present disclosure;

FIG. 2 shows a schematic view of a fuel cell according to an exemplary embodiment of the present disclosure;

FIG. 3 shows a partial sectional view of the fuel cell in FIG. 2 along section line A-A;

FIG. 4 shows a flow chart for manufacturing a fuel cell according to an exemplary embodiment of the present disclosure.

### SPECIFIC EMBODIMENTS

To provide a clearer understanding of the technical problems, technical solutions, and beneficial technical effects addressed by the present disclosure, the present disclosure will be described in detail below with reference to the accompanying drawings and a plurality of exemplary embodiments. It should be understood that the specific embodiments described herein are only intended to explain the present disclosure and not to limit the scope of protection of the present disclosure. For brevity, elements with the same reference numerals in the accompanying drawings are only labelled once herein.

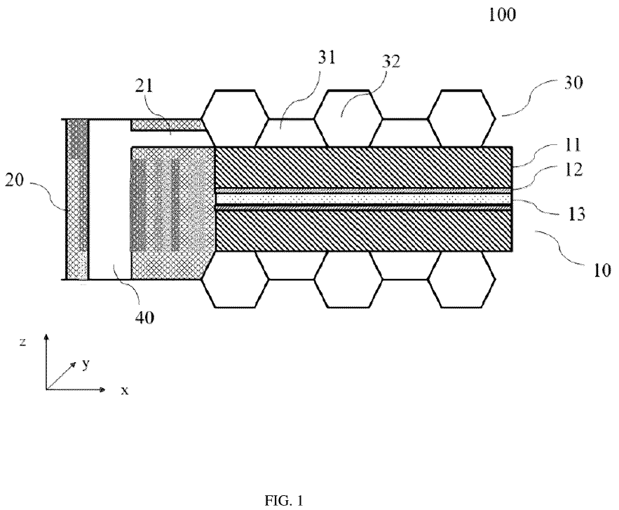

FIG. 1 shows a partial sectional view of a fuel cell 100 according to an exemplary embodiment of the present disclosure. The fuel cell 100 herein is a proton exchange membrane fuel cell and is particularly used as a power source in electric vehicles or hybrid vehicles.

As shown in FIG. 1, the fuel cell 100 includes a membrane electrode assembly 10, a sealing frame 20 surrounding the membrane electrode assembly 10, bipolar plates 30 arranged on both sides of the membrane electrode assembly 10 and the sealing frame 20, and a manifold portion 40 for supplying and discharging reactant gas, which may be fuel or oxidizing agents. Further, the fuel cell 100 also includes end plates and a holder not shown herein, with the end plates abutting both ends of the fuel cell 100 and providing protection, and the holder configured to clamp the assemblies of the fuel cell 100 together. These assemblies are collectively assembled to form a fuel cell stack. The main extension plane of the fuel cell 100 herein is located in the xy plane.

As shown in FIG. 1, the membrane electrode assembly 10 is composed of two gas diffusion layers 11 and two catalyst layers 12 respectively located on the anode side and cathode side, and a proton exchange membrane 13 located in the middle. The membrane electrode assembly 10 herein acts as the core component of the fuel cell 100, wherein fuel, typically, hydrogen, is supplied to the anode of the membrane electrode assembly 10, reaches the anode catalyst layer through the gas diffusion layer 11, and under the catalytic action of the anode catalyst, for example, platinum, decomposes into hydrogen ions and releases two electrons. The hydrogen ions then pass through the proton exchange membrane 13 to reach the cathode, where under the action of the cathode catalyst, they react with the oxidizing agent, for example, air or pure oxygen, supplied to the cathode catalyst layer through the gas diffusion layer 11 on the other side to generate water, while the released electrons form an electric current in the external circuit.

Exemplarily, the gas diffusion layer 11, the catalyst layer 12, and the proton exchange membrane 13 have the same extended dimensions in the main extension plane of the fuel cell 100. It may be contemplated herein to collectively construct the catalyst layer 12 and the proton exchange membrane 13 as catalyst-coated membranes. However, the gas diffusion layer 11, the catalyst layer 12, and the proton exchange membrane 13 may be contemplated to have different extended dimensions, respectively.

As shown in FIG. 1, the sealing frame 20 of the fuel cell 100 surrounds the membrane electrode assembly 10 circumferentially, thereby preventing leakage of supplied fuel and oxidizing agents as a seal and ensuring that the fuel cell 100 works safely and efficiently.

As shown in FIG. 1, two bipolar plates 30 of the fuel cell 100 are assembled on both sides of the membrane electrode assembly 10 and the sealing frame 20, respectively, and sandwich them in the middle. The bipolar plates 30 herein apply a clamping force from both sides in the z-direction, or in the perpendicular direction, to ensure secure assembly of the membrane electrode assembly 10 and the sealing frame 20, where the clamping force applied by the bipolar plates 30 is largely borne by the sealing frame 20, preventing mechanical damage to the membrane electrode assembly 10.

As shown in FIG. 1, the bipolar plates 30 are composed of two thin plates, for example, metal plates, joined together and are exemplarily stamped to form a gas distributing structure 31 through which reactant gas, i.e., hydrogen or oxygen, is evenly distributed onto the reaction layer of the membrane electrode assembly 10, thereby optimizing the reaction efficiency and output power of the fuel cell 100. Depending on the position of the bipolar plates 30, the gas distributing structure 31 herein may function as a fuel distributing structure for directing and distributing fuel on the anode side and as an oxidizing agent distribution structure for directing and distributing oxidizing agent on the cathode side, respectively. Further, a coolant flow channel 32 is provided in the bipolar plates 30, through which the coolant can flow through the surface of the membrane electrode assembly 10 and effectively discharge heat generated by the chemical reaction.

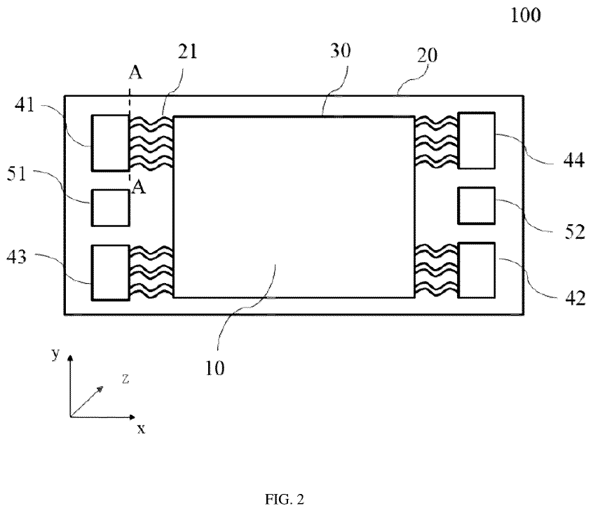

As shown in FIG. 1, the manifold portion 40 of the fuel cell 100 is constructed for supplying and discharging reactant gas, i.e., fuel and oxidizing agent. The manifold portion 40 herein exemplarily traverses a plurality of fuel cells in a fuel cell stack. Depending on the function, the manifold portion 40 may be divided into a fuel supply manifold portion, a fuel discharge manifold portion, an oxidizing agent supply manifold portion, and an oxidizing agent discharge manifold portion, as detailed in FIG. 2.

As shown in FIG. 1, to achieve fluid communication between the manifold portion 40 and the gas distributing structure 31 of the bipolar plates 30, a gas flow channel 21 is provided in the sealing frame 20, the gas flow channel extending from the manifold portion 40 to the gas distributing structure 31 of the bipolar plates 30 such that the reactant gas is capable of passing through the gas flow channel 21 into the gas distributing structure 31 to avoid disposing, in particular, stamping air holes on the bipolar plates 30. This not only simplifies the manufacturing of the bipolar plates 30, but also prevents a large drop in pressure in the reactant gas entering the gas distributing structure 31 through the air holes of the bipolar plates 30. According to the present disclosure, the gas flow channel 21 has a shape with a winding path, at least partially, in the main extension plane xy of the fuel cell 100, as detailed in FIG. 2.

Exemplarily, the sealing frame 20 with the gas flow channel 21 is manufactured in an integrated manner from a rubber material through an injection moulding process, which simplifies the manufacturing process of the sealing frame 20 and the assembly process of the entire fuel cell 100. The sealing frame 20 herein may be manufactured from one or more of materials such as silicone rubber, ethylene propylene diene monomer, polyethylene naphthalate, polyethylene terephthalate, or the like.

Exemplarily, the manifold portion 40 is integrated directly into the sealing frame 20 or otherwise constructed integrally with the sealing frame 20. However, it may be contemplated to construct the manifold portion 40 separately from the sealing frame 20.

FIG. 2 shows a schematic diagram of a fuel cell 100 according to an exemplary embodiment of the present disclosure.

As shown in FIG. 2, the manifold portion 40 of the fuel cell 100 includes a fuel supply manifold portion 41 for supplying fuel, a fuel discharge manifold portion 41 for discharging fuel, an oxidizing agent supply manifold portion 43 for supplying oxidizing agent, and an oxidizing agent discharge manifold portion 44 for discharging oxidizing agent. Fuel supplied by the fuel supply manifold portion 41 herein flows through the gas distributing structure 31 of the bipolar plate 30 on the anode side to the fuel discharge manifold portion 42 and the oxidizing agent supplied by the oxidizing agent supply manifold portion 43 flows through the gas distributing structure 31 of the bipolar plate 30 on the cathode side to the oxidizing agent discharge manifold portion 44. Each manifold portion 40 herein is in fluid communication with the gas distributing structure 31 through the corresponding gas flow channel 21 in the sealing frame 20, respectively.

As shown in FIG. 2, the gas flow channel 21 in the sealing frame 20 has a shape with a winding path, at least partially and in particular completely, in the main extension plane xy of the fuel cell 100. The sealing frame 20 herein is subject to a clamping force in the z-direction applied by the bipolar plates 30 from both sides, which results in compression deformation of the sealing frame 20 itself, and the winding path configuration of the gas flow channel 21 effectively reduces deformation of the sealing frame 20 and prevents collapse of the gas flow channel 21.

Exemplarily, the gas flow channel 21 has a wave shape in the main extension plane xy of the fuel cell 100. The wave shape configuration of the gas flow channel 21 is capable of improving the flow characteristics of the reactant gas in the gas flow channel 21 and minimizing the drop in pressure of the gas, thereby advantageously increasing the flow capacity of the reactant gas. Further, those skilled in the art may contemplate other meaningful configurations of the gas flow channel 21, for example, a flow channel configuration with continuous 90° bends.

Exemplarily, the wavelength and amplitude of the wave shape of the gas flow channel 21 depends on the material properties of the sealing frame 20. The sealing frame 20 may thus be cost-effectively and easily manufactured.

Exemplarily, a plurality of, for example, three, gas flow channels 21 are disposed for each manifold portion 40, and these gas flow channels are arranged in parallel and evenly spaced apart from each other, as shown in FIG. 2. The reactant gas may thereby enter the gas distributing structure 31 more evenly. Of course, any other number of gas flow channels 21 may be contemplated.

Exemplarily, the fuel supply manifold portion 41 and the fuel discharge manifold portion 42 are arranged along a diagonal of the fuel cell 100, and the oxidizing agent supply manifold portion 43 and the oxidizing agent discharge manifold portion 44 are similarly arranged along a diagonal line of the fuel cell 100. The flow path of the reactant gas in the gas distributing structure 31 of the bipolar plates 30 may be optimized, such that the reactant gas is distributed as evenly as possible onto the membrane electrode assembly 10.

As shown in FIG. 2, the fuel cell 100 also includes a coolant supply portion 51 for supplying coolant and a coolant discharge portion 52 for discharging the coolant, wherein the coolant supplied by the coolant supply portion 51 flows through the coolant flow channel 32 of the bipolar plates 30 to the coolant discharge portion 52, thereby taking away the reaction heat generated at the membrane electrode assembly 10. It may be contemplated herein to similarly integrate the coolant supply portion 51 and the coolant discharge portion 52 into the sealing frame 20.

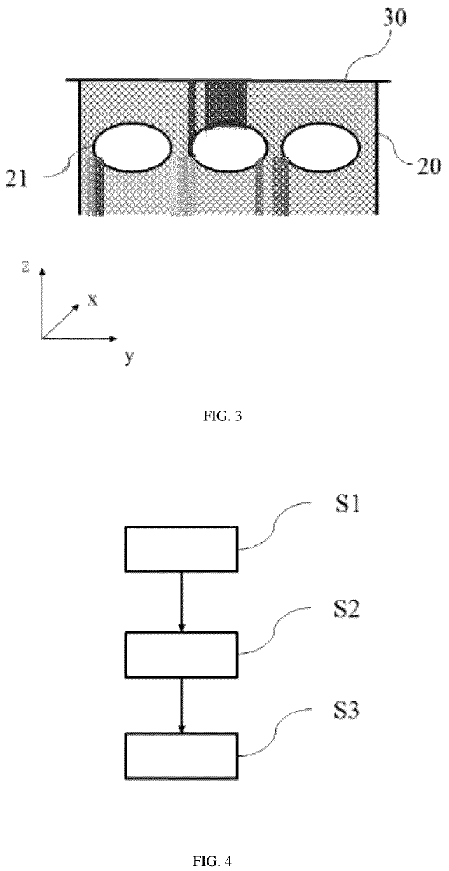

FIG. 3 shows a partial sectional view of the fuel cell 100 of FIG. 2 along section line A-A, the partial cross-sectional view is in a zy plane.

As shown in FIG. 3, the cross-sectional shape of the gas flow channel 21 is an oval and the cross-section is perpendicular to the airflow direction in the gas flow channel 21. However, it may be contemplated for the gas flow channel 21 to have other cross-sectional shapes, for example, circle, square, arc, or similar shapes.

As shown in FIG. 3, one manifold portion 40 has three matching gas flow channels 21, which are relatively evenly spaced apart from one another. Of course, those skilled in the art may contemplate other meaningful numbers of gas flow channels 21.

FIG. 4 shows a flow chart of a method for manufacturing a fuel cell 100 according to an exemplary embodiment of the present disclosure.

As shown in FIG. 4, the method at least comprises the following steps:
S1: placing the prepared membrane electrode assembly 10 in a pre-designed mould;
S2: injecting a sealing material in the liquid state into the mould and cooling and curing so as to form the sealing frame 20, wherein the gas flow channel 21 is disposed in the sealing frame 20;
S3: assembling bipolar plates 30 on both sides of the membrane electrode assembly 10 and the sealing frame 20;
wherein the gas flow channel 21 extends from the manifold portion 40 of the fuel cell 100 to the gas distributing structure 31 of the bipolar plates 30 and the gas flow channel 21, at least partially, has a shape with a winding path in the main extension plane xy of the fuel cell 100.

Exemplarily, in step S1, the membrane electrode assembly 10 is prepared as follows: the gas diffusion layer 11, catalyst layer 12, and proton exchange membrane 13 are cut to the same extended dimensions. Further, it may be contemplated to construct the catalyst layer 12 and proton exchange membrane 13 as catalyst-coated membranes. This may simplify the assembly of the membrane electrode assembly 10.

Exemplarily, in step S2, the sealing frame 20 is integrally constructed through an injection moulding process, where the gas flow channel 21 is disposed in the sealing frame, achieving fluid communication of the manifold portion 40 with the gas distributing structure 31 of the bipolar plates 30 via the gas flow channel 21 after the bipolar plates 30 are assembled.

The foregoing description of embodiments only describes the present disclosure within the framework of the examples. Certainly, as long as it is technically meaningful, the various features of the embodiments may be freely combined with each other without departing from the framework of the present disclosure.

For those skilled in the art, other advantages and alternative embodiments of the present disclosure are apparent. Therefore, in terms of its broader significance, the present disclosure is not limited to the specific details, representative structures, and exemplary embodiments shown and described. On the contrary, those skilled in the art may make various modifications and substitutions without departing from the essential spirit and scope of the present disclosure.

1. A fuel cell, comprising:
a membrane electrode assembly;
a sealing frame surrounding the membrane electrode assembly;
a manifold portion configured to supply or discharge reactant gas; and
bipolar plates arranged on both sides of the membrane electrode assembly and the sealing frame and having a gas distributing structure configured to distribute the reactant gas onto the membrane electrode assembly,
wherein a gas flow channel is provided in the sealing frame, the gas flow channel extending from the manifold portion to the gas distributing structure of the bipolar plates, and
wherein the gas flow channel has a shape with a winding path, at least partially, in the main extension plane in the fuel cell.

2. The fuel cell according to claim 1, wherein the gas flow channel has a wave shape in the main extension plane.

3. The fuel cell according to claim 1, wherein the cross-sectional shape of the gas flow channel is a circle, an oval, a square, or an arc.

4. The fuel cell according to claim 1, wherein:
the manifold portion comprises a fuel supply manifold portion, a fuel discharge manifold portion, an oxidizing agent supply manifold portion and an oxidizing agent discharge manifold portion, and
the fuel supply manifold portion and the fuel discharge manifold portion are arranged along a diagonal line of the fuel cell, and the oxidizing agent supply manifold portion and the oxidizing agent discharge manifold portion are arranged along a diagonal line of the fuel cell.

5. The fuel cell according to claim 4, wherein:
a plurality of gas flow channels are disposed for each manifold portion, and
the gas flow channels are arranged in parallel and evenly spaced apart from each other.

6. The fuel cell according to claim 1, wherein the sealing frame is integrally manufactured from a rubber material through an injection moulding process.

7. The fuel cell according to claim 2, wherein the wavelength and/or amplitude of the wave shape of the gas flow channel is associated with the material properties of the sealing frame.

8. The fuel cell according to claim 1, wherein the manifold portion is integrated into the sealing frame.

9. The fuel cell according to claim 1, wherein the membrane electrode assembly consists of a gas diffusion layer, a catalyst layer, and a proton exchange membrane having the same extended dimensions.

10. A method for manufacturing the fuel cell according to claim 1, the method comprising:
placing a prepared membrane electrode assembly in a pre-designed mould;
injecting a sealing material in the liquid state into the mould and curing so as to form a sealing frame, wherein a gas flow channel is disposed in the sealing frame; and
assembling the bipolar plates on both sides of the membrane electrode assembly and the sealing frame,
wherein the gas flow channel extends from a manifold portion of the fuel cell to a gas distributing structure of the bipolar plates, and
wherein the gas flow channel has a shape with a winding path, at least partially, in the main extension plane of the fuel cell.
